(19) United States
(12) Patent Application Publication
(10) Pub. No.: US 2024/0405249 A1
(43) Pub. Date: Dec. 5, 2024

(54) MANUFACTURING MACHINE AND METHOD TO MANUFACTURE A CYLINDRICAL BATTERY

(71) Applicant: G.D S.P.A., Bologna (IT)

(72) Inventors: Massimo Fortini, Bologna (IT); Giacomo Noferini, Bologna (IT); Giuliano Gamberini, Bologna (IT)

(21) Appl. No.: 18/720,129

(22) PCT Filed: Dec. 13, 2022
(86) PCT No.: PCT/IB2022/062126

§ 371 Date: Jun. 14, 2024

(30) Foreign Application Priority Data
Dec. 15, 2021 (IT) 102021000031478
Dec. 22, 2021 (IT) 102021000032255

(51) Int. Cl. H01M 10/04; H01M 50/167

(52) U.S. Cl. CPC H01M 10/0404; H01M 10/0422; H01M 50/167

(57) ABSTRACT

A manufacturing machine for manufacturing a cylindrical battery having a cylindrical case which houses an electrochemical cell. They are provided: a processing conveyor configured to move forward along a processing path a seat designed to support the cylindrical case; and an operating group which is arranged along the processing path and is configured to perform a processing on the cylindrical case. The operating group has: a support body axially aligned with the corresponding seat and mounted to rotate around a rotation axis; and a plurality of processing discs, which are configured to perform a machining on the side wall of the cylindrical case, are uniformly mounted on the support body to form a circle at the centre of which the cylindrical case is placed in use, and are radially movable to radially get close to and move away from the cylindrical case which is in use between them.

### CROSS-REFERENCE TO RELATED APPLICATION DATA

This application is a U.S. National Stage Application of International Application No. PCT/IB2022/062126, filed Dec. 13, 2022, which claims the benefit of and priority to Italian Patent Application No. 102021000031478, filed Dec. 15, 2021 and Italian Patent Application No. 102021000032255, filed Dec. 22, 2021, the disclosure of each is incorporated herein by reference in its entirety.

### FIELD OF THE ART

The present invention relates to a manufacturing machine and a method to manufacture a cylindrical battery.

The present invention may be advantageously applied to the production of a cylindrical lithium-ion battery, to which the following description will make explicit reference without losing generality.

### BACKGROUND OF THE INVENTION

Commercial lithium-ion batteries are assembled in three different geometries: cylindrical, prismatic and pouch.

Cylindrical batteries consist of a cylinder-shaped metal case with a single electrochemical cell therein, consisting of an anode, separator and cathode rolled with each other around a central pivot.

In particular, the cylindrical case is initially open on one side (i.e. it is cup-shaped with a closed lower end and an open upper end) to allow introducing the wound electrochemical cell and the electrolyte impregnating the wound electrochemical cell; once the battery has been formed (i.e. once all the components have been arranged inside the cylindrical case), the open end of the cylindrical case is closed, forming a sealed closure.

In particular, in order to close the open end of a cylindrical case, a circular lid (possibly coupled with an annular gasket) is used, which is connected to the cylindrical case by deforming an upper edge of the cylindrical case against the lid.

### SUMMARY

An object of the present invention is to provide a manufacturing machine and a method of manufacturing a cylindrical battery that allow to operate at a high production speed (measured as cylindrical batteries produced in a unit of time) while ensuring high quality of the final product.

According to an aspect of the present invention, a cylindrical battery manufacturing machine is provided as comprising a cylindrical case which houses an electrochemical cell, the manufacturing machine comprising:
a processing conveyor configured to move forward along a processing path a seat designed to support the cylindrical case, and
an operating group which is arranged along the processing path and is configured to perform a processing on the cylindrical case,
wherein the operating group comprises:
a support body which is axially aligned with the corresponding seat and mounted to rotate around a first rotation axis, and
a plurality of processing discs, which are designed to perform a processing on a side wall of the cylindrical case, are mounted on the support body so as to form a circle at the centre of which, in use, the cylindrical case is arranged and are radially movable so as to radially get close to and move away from the cylindrical case which is, in use, between them.

Preferably, each processing disc is mounted in a rotary manner on the support body to rotate around a second rotation axis parallel to the first rotation axis.

Preferably, each processing disc is mounted in an idle manner to freely rotate around the second rotation axis.

Preferably, each processing disc is mounted in a rotary manner on the support body to rotate around a third rotation axis parallel to the second rotation axis and eccentric to the processing disc in such a way that the rotation around the third rotation axis causes a radial displacement of the processing disc.

Preferably, the operating group comprises an actuator device that is configured to rotate all the processing discs in a synchronized manner around the corresponding third rotation axes between a loading/unloading position in which the processing discs are at a non-zero distance from the cylindrical case which, in use, is between them and a working position in which the processing discs touch the cylindrical case which, in use, is between them. Preferably, the operating group comprises a plurality of columns, each of which supports, at one end, a corresponding processing disc that is mounted to rotate around the second rotation axis with respect to the column and, at an opposite end, is hinged to the support body to rotate around the corresponding third rotation axis.

Preferably, the manufacturing machine comprises a lifting device which is axially movable and is configured to extract the cylindrical case from the corresponding seat by coupling the cylindrical case to the operating group and to re-insert the cylindrical case into the corresponding seat by uncoupling the cylindrical case from the operating group. Preferably, in the middle of the support body of the operating group a central abutment element is arranged, which does not rotate with the support body and against which the cylindrical case, which is coupled with the operating group, is pushed.

Preferably, the processing discs are evenly distributed around the first rotation axis.

Preferably, the operating group is configured to move with the processing conveyor in an integral manner.

Preferably, the processing conveyor is a processing wheel.

In embodiments, the manufacturing machine comprises a first, second and third processing wheel, each processing wheel being configured to move forward a seat along a respective processing path.

The present invention also relates to a method of manufacturing a cylindrical battery comprising a cylindrical case which houses an electrochemical cell and is closed at the top by a lid, the manufacturing method comprising:
moving forward, by means of a processing conveyor, along a processing path a seat designed to support the cylindrical case; and
performing, by means of an operating group arranged along the processing path, a
processing on the cylindrical case;
wherein the operating group comprises:
a support body which is axially aligned with the corresponding seat and mounted to rotate around a rotation axis, and
a plurality of processing discs, which are designed to perform a processing on the side wall of the cylindrical case, are mounted on the support body so as to form a circle at the centre of which the cylindrical case, in use, is arranged, and are radially movable so as to radially get close to and move away from the cylindrical case which is, in use, between them.

The claims describe embodiments of the present invention forming an integral part of the present disclosure.

### BRIEF DESCRIPTION OF THE DRAWINGS

The present invention will now be described with reference to the accompanying drawings, which show a non-limiting embodiment thereof, wherein:

FIG. 1 is a schematic view of a cylindrical battery;

FIG. 2 is a schematic and enlarged scale view of an upper end of the cylindrical battery of FIG. 1;

FIGS. 3-9 schematically show a series of operations to close, at the top, a cylindrical case of the cylindrical battery of FIG. 1;

FIG. 10 is a schematic plan view of a manufacturing machine that makes the cylindrical battery of FIG. 1 and in particular makes the upper closure of the cylindrical case of the cylindrical battery of FIG. 1;

FIG. 11 is a schematic frontal view of a first processing wheel of the manufacturing machine of FIG. 10;

FIG. 12 is a perspective view of an operating group of the first processing wheel of FIG. 11;

FIG. 13 is a schematic frontal view of a second processing wheel of the manufacturing machine of FIG. 10;

FIGS. 14 and 15 are two schematic frontal views of a feeding unit of the manufacturing machine of FIG. 10 in two different operation instants;

FIG. 16 is a schematic frontal view of a third processing wheel of the manufacturing machine of FIG. 10;

FIG. 17 is a frontal and schematic view of a detail of an operating group of the third processing wheel of FIG. 16; and

FIG. 18 is a schematic frontal view of a compression unit present in a variant of the manufacturing machine of FIG. 10.

### DETAILED DESCRIPTION

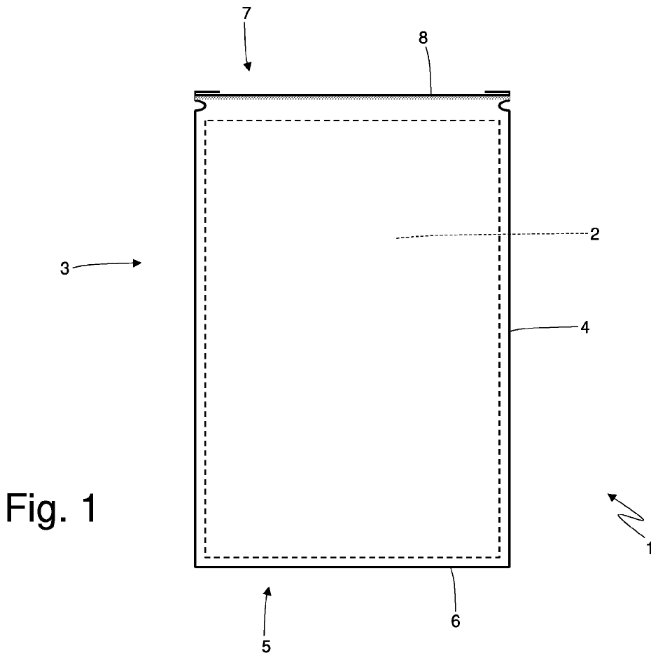

In FIG. 1 an electric power energy cylindrical battery is globally denoted by number 1. The cylindrical battery 1 comprises a “jelly-roll” or “swiss-roll” electrochemical cell 2 consisting of several sheets superimposed on top of each other and then wound to take on a cylindrical shape, and a cylindrical case 3 enclosing the electrochemical cell 2 therein. The cylindrical case 3 has a cylinder-shaped side wall 4, a lower end 5 which is closed from the beginning by a lower wall 6 which is connected without interruption to the side wall 4, and an upper end 7 which is opposite to the lower end 5, is initially open to allow the insertion of the electrochemical cell 2 and is subsequently closed and sealed.

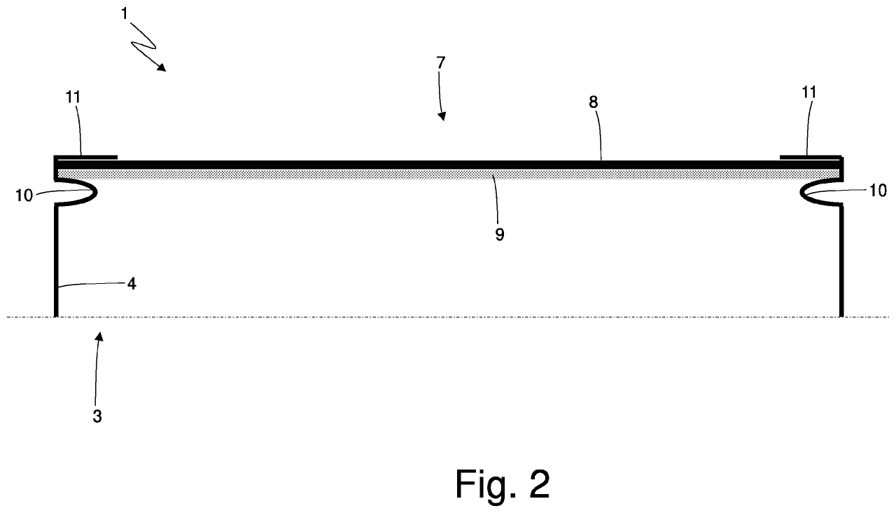

As better shown in FIG. 2, at the upper end 7 of the cylindrical case 3, a circular lid 8 is arranged, which forms the closure of the upper end 7 (i.e. it constitutes an upper base of the cylindrical case 3). The lid 8 is coupled with an annular gasket 9 which is interposed between the lid 8 and the side wall 4 of the cylindrical case 3. In particular, the lid 8 and annular gasket 9 assembly is clamped between an annular groove 10 formed (by deformation) in the side wall 4 and an edge 11 of the side wall 4 that has been deformed against the lid 8.

The cylindrical battery 1 comprises an electrical pole (positive or negative) arranged (with adequate electrical insulation) at the lower wall 6 and an opposite electrical pole (negative or positive) arranged (with adequate electrical insulation) at the lid 8.

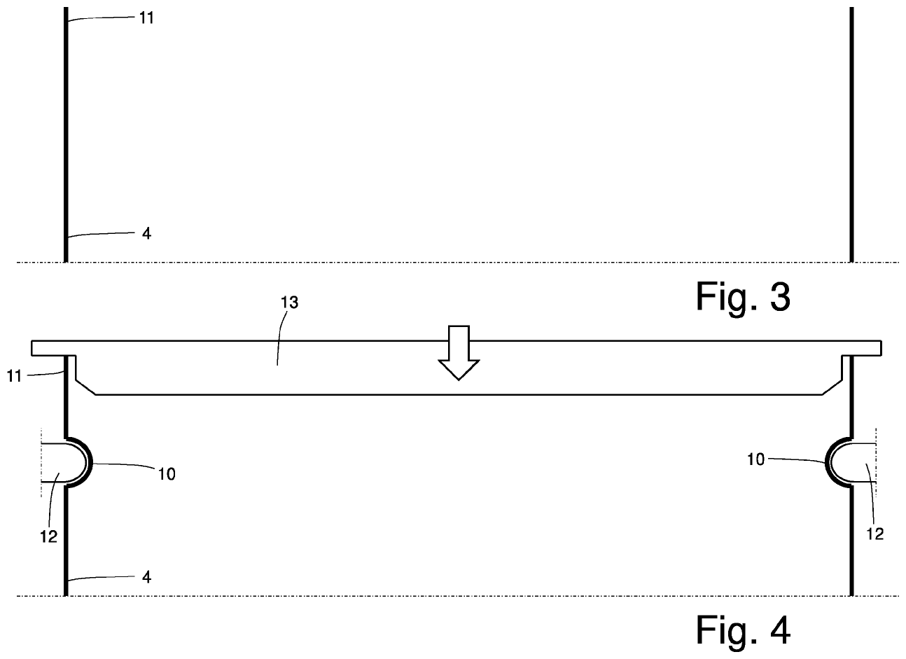

With reference to FIGS. 3-9, it is hereinafter described how to close the open upper end 7 of the cylindrical case 3.

As shown in FIG. 3, the side wall 4 of the cylindrical case 3 is initially perfectly cylindrical (even at the edge 11) without any deformation to allow easily inserting the electrochemical cell 2.

As shown in FIG. 4, once the electrochemical cell 2 has been inserted into the cylindrical case 3, the side wall 4 of the cylindrical case 3 (below the edge 11) is plastically deformed to form the annular groove 10. In order to perform this operation, a deforming tool 12 is used, which plastically deforms the side wall 4 of the cylindrical case 3; preferably, in combination with the action of the deforming tool 12, a pressor element 13 is also used which axially compresses the side wall 4 of the cylindrical case 3 in order to promote deformation of the side wall 4 at the deforming tool 12. According to a preferred embodiment, the pressor element 13 has a central protrusion that is inserted into the side wall 4 of the cylindrical case 3 with a small clearance in order to centre the side wall 4 (i.e. to arrange the side wall 4 in a known and predetermined position).

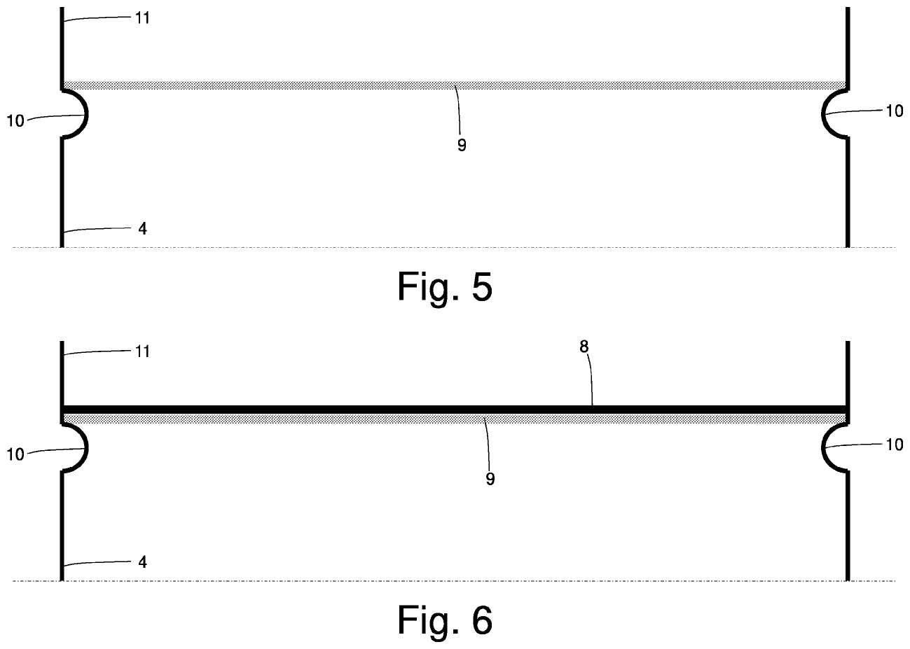

As shown in FIG. 5, the gasket 9 is then laid on the annular groove 10 (which constitutes a support base).

As shown in FIG. 6, the lid 8 is then laid on the annular groove 10 (which constitutes a support base and with the interposition of the previously arranged gasket 9). Alternatively, the lid 8 may be coupled to the gasket 9 beforehand, and then the lid 8 and gasket 9 assembly is laid on the annular groove 10.

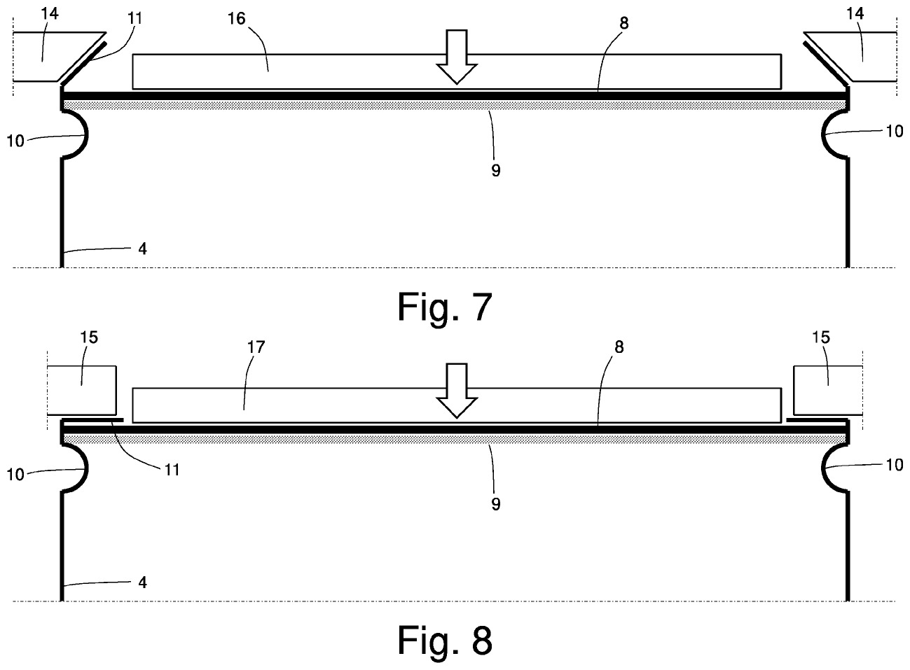

As shown in FIGS. 7 and 8, the edge 11 is then bent against the lid 8 and gasket 9 assembly to clamp (retain) the lid 8 and gasket 9 assembly against the underlying groove 10. Preferably, this operation is carried out in two successive steps: initially, the edge 11 is bent by about 40-50° towards assembly of lid 8 and gasket 9 (as shown in FIG. 7) by means of a bending tool 14, and only after is the edge 11 further bent until it reaches a 90° bend against the lid 8 and the gasket 9 assembly (as shown in FIG. 8) by means of a bending tool 15 (different in shape from the bending tool 14). Preferably, in combination with the action of the bending tool 14 a pressor element 16 which axially presses on the lid 8 is also used; similarly, also in combination with the action of the bending tool 15 a pressor element 17 which axially presses on the lid 8 is also used.

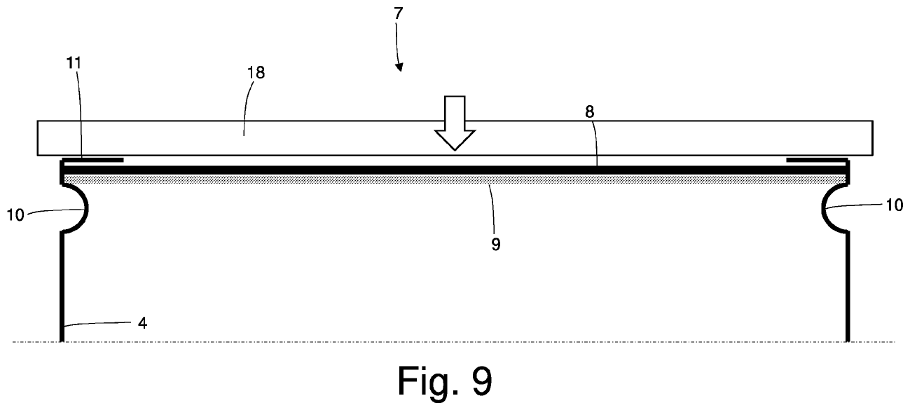

The last operation that is carried out is an axial compression of the whole cylindrical case 3 (shown in FIG. 9), which causes an axial plastic deformation of the groove 10 and a compaction of the edge 11 against the lid 8; in order to carry out this axial compression, a pressor element 18 which presses on the entire upper end 7 of the cylindrical case 3 is used. The result of the axial compression is clear by comparing FIG. 9 showing a cylindrical case 3 prior to the axial compression and FIG. 2 showing a cylindrical case 3 after the axial compression.

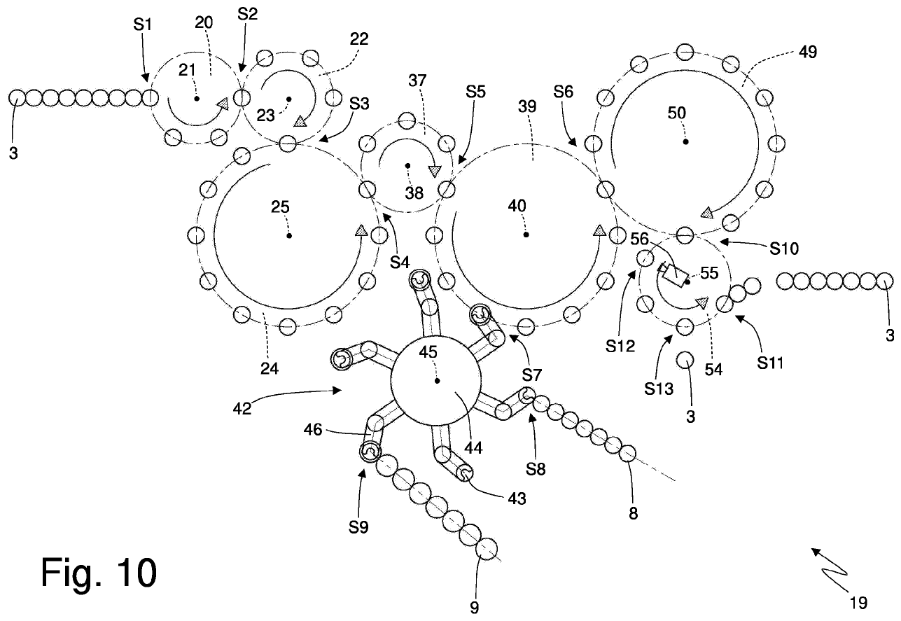

In FIG. 10 a manufacturing machine which produces the cylindrical battery 1 and in particular which performs the upper closure of the cylindrical case 3 of the battery 1 is globally denoted by number 19.

The manufacturing machine 19 comprises a horizontal conveyor (not shown) that moves forward a series of cylindrical cases 3 containing the electrochemical cells 2 and that are open at the top along an inlet path that ends at an exchange station S1.

The manufacturing machine 19 comprises a horizontal transfer wheel 20 that is mounted to rotate around a vertical rotation axis 21 (perpendicular to the plane of the sheet), receives the cylindrical cases 3 in the exchange station S1, and leaves the cylindrical cases 3 at an exchange station S2.

The manufacturing machine 19 comprises a horizontal transfer wheel 22 which is mounted to rotate around a vertical rotation axis 23 (parallel to the rotation axis 21), receives the cylindrical cases 3 at the exchange station S2, and leaves the cylindrical cases 3 at an exchange station S3.

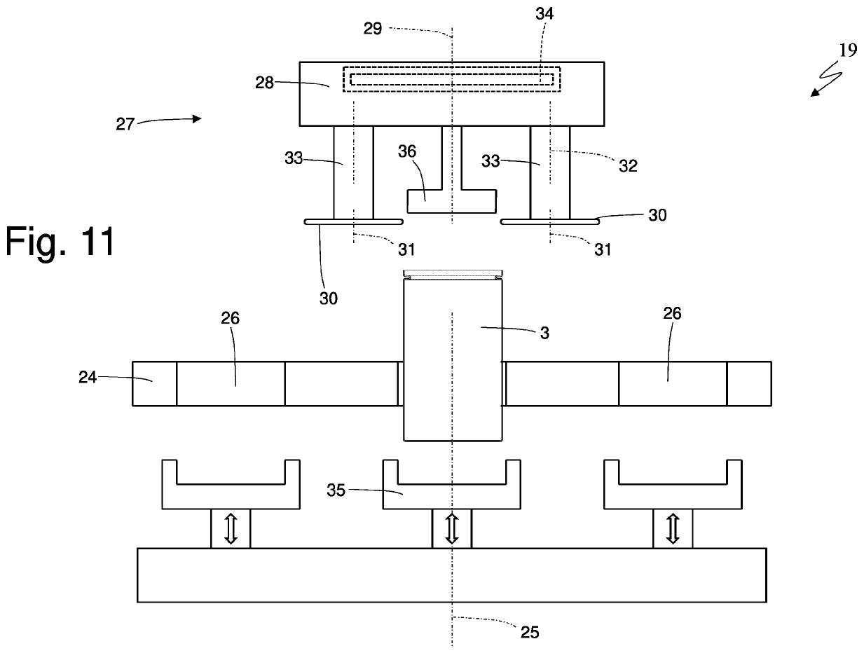

The manufacturing machine 19 comprises a first horizontal processing wheel 24 that is mounted to rotate around a vertical rotation axis 25 (parallel to the rotation axis 23), receives the cylindrical cases 3 at the exchange station S3 and leaves the cylindrical cases 3 at an exchange station S4. As shown in FIG. 11, the processing wheel 24 supports a plurality (e.g. twelve) of seats 26 which are evenly distributed along the periphery of the processing wheel 24 and are moved forward by the rotation of the processing wheel 24 around the rotation axis 25 along a circular processing path extending between the interchange stations S3 and S4 (i.e. the processing path starts at the interchange station S3 and ends at the interchange station S4). Each seat 26 is designed to laterally grab a corresponding cylindrical case 3 (i.e. the seat 26 engages part of the side wall 4 of the cylindrical case 3) by, for instance, retaining the cylindrical case 3 by suction; the cylindrical case 3 can thereby translate axially (i.e. parallel to the rotation axis 25) with respect to the corresponding seat 26 (according to ways described hereinafter).

Each seat 26 of the processing wheel 24 is coupled to a corresponding operating group 27 which is carried by the processing wheel 24 to move (rotate) integrally with the processing wheel 24 itself. Each operating group 27 is configured to form the annular groove 10 on the side wall 4 of the cylindrical case 3 carried by the corresponding seat 26. In other words, as many operating groups 27 as the seats 26 are provided and thus each operating group 27 always works with only one corresponding seat 26. Each operating group 27 is arranged along the processing path defined by the processing wheel 24 to obtain the annular groove 10 in a cylindrical case 3 moving forward along the processing path supported by the corresponding seat 26. For sake of simplicity, only three seats 26 and only one operating group 27 are shown in FIG. 11, but actually twelve seats 26 and twelve corresponding operating groups 27 are provided.

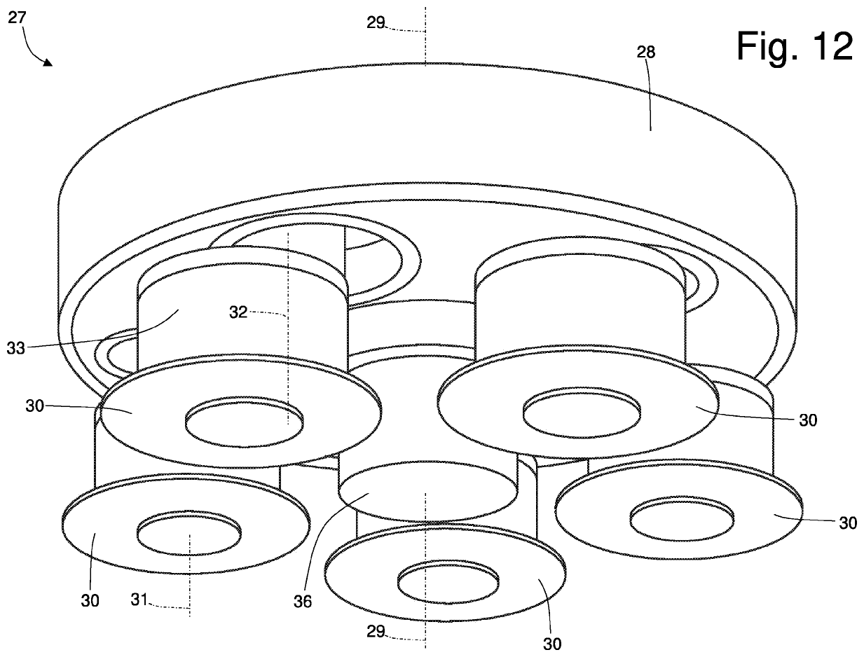

As shown in FIGS. 11 and 12, each operating group 27 is mounted on the processing wheel 24 to rotate integrally with the processing wheel 24 and comprises a support body 28 which is axially aligned with the corresponding seat 26 and is mounted to rotate around a vertical rotation axis 29 parallel to the rotation axis 25. In other words, each support body 28 is coaxial to the corresponding seat 26 and rotates around its own central rotation axis 29 arranged alongside (at a certain distance) from the rotation axis 25 of the processing wheel 24.

Each operating group 27 comprises a plurality of processing (deforming) discs 30, which are designed to deform the side wall 4 of the cylindrical case 3 carried by the corresponding seat 26 to form the annular groove 10. In the embodiment shown in FIG. 12, each operating group 27 comprises five processing discs 30 evenly (symmetrically) distributed around the rotation axis 29; alternatively, a different number (e.g. from two to eight) of processing discs 30 evenly (symmetrically) distributed around the rotation axis 29 (i.e. arranged at the vertices of a regular polygon centred on the rotation axis 29) could be provided. Thus, the processing discs 30 are distributed around the rotation axis 29 so as to make uniform the pressure exerted by the processing discs 30 on the cylindrical case 3 being processed, as the thrust (pressure) exerted by each processing disc 30 is balanced (compensated) by the thrust (pressure) exerted by the other processing discs 30.

In other words, the edge of each processing disc 30 constitutes a deforming tool 12 shown in FIG. 4.

In each operating group 27, the processing discs 30 (all coplanar to each other, i.e. arranged at the same vertical height) are symmetrically mounted on the support body 28 to form a circle at the centre of which the cylindrical case 3 is arranged in use, and are radially movable to radially get close to and move away from the cylindrical case 3 which is in use between them.

In particular, each processing disc 30 is mounted in a rotary manner on the support body 28 to rotate around a vertical rotation axis 31 parallel to the rotation axis 29; according to a preferred embodiment, each processing disc 30 is mounted in an idle manner on the support body 28 to freely rotate (i.e. without constraint and without external actuation) around the rotation axis 31. Furthermore, according to a preferred embodiment, each processing disc 30 is mounted in a rotary manner on the support body 28 to rotate around a vertical rotation axis 32 that is parallel to the rotation axis 31 and is eccentric with respect to the processing disc 30 such that rotation around the rotation axis 32 causes a radial displacement of the processing disc 30.

According to a preferred embodiment, each operating group 27 comprises a plurality of columns 33, each of which supports, at one end, a corresponding processing disc 30 which is mounted (in an idle manner) to rotate around the corresponding rotation axis 31 with respect to the column 33 and, at an opposite end, is hinged to the support body 28 to rotate around the corresponding rotation axis 32 (eccentric with respect to the processing disc 30).

Each operating group 27 comprises an actuator device 34 (schematically shown in FIG. 11) that rotates all the processing discs 30 in a synchronous manner around the corresponding rotation axes 32 between a loading/unloading position in which the processing discs 30 are at a non-zero distance from the cylindrical case 3 that is, in use, in the middle of them and a working position in which the processing discs 30 touch the cylindrical case 3 that is, in use, in the middle of them. In use, the processing discs 30 of each operating group 27 are arranged in the loading/unloading position to axially insert a cylindrical case 3 between the processing discs 30 or to axially remove a cylindrical case 3 from the processing discs 30, and the processing discs 30 of each operating group 27 are arranged in the working position to be able to act on the cylindrical case 3 itself.

For each seat 26, a corresponding lifting device 35 (shown in FIG. 11) is provided which is carried by the processing wheel 24 to move (rotate) integrally with the processing wheel 24 itself, is axially movable (i.e. along the rotation axis 25) and is configured to extract the cylindrical case 3 from the corresponding seat 26 by coupling the cylindrical case 3 to the corresponding operating group 27 (which is located above the seat 26) and re-insert the cylindrical case 3 into the corresponding seat 26 by uncoupling the cylindrical case 3 from the operating group 27.

In the middle of the support body 28 of each operating group 27 there is a central abutment element 36 which is integral with the processing wheel 24 and therefore does not rotate with the support body 28 and against which the cylindrical case 3, which is coupled to the operating group 27, is pushed; namely, the central abutment element 36 is stationary with respect to the processing wheel 24 and therefore the support body 28 rotates around the central abutment element 36. A lower portion of the abutment element 36 defines (supports) the pressor element 13 shown in FIG. 4.

According to a preferred embodiment, the central abutment element 36 of each operating group 27 does not perform any movement (neither rotation nor translation) with respect to the processing wheel 24, as all the axial movement (i.e. parallel to the rotation axis 25) of the cylindrical cases 3 is entrusted to the lifting devices 35; thus, each abutment element 36 establishes only a fixed abutment that applies axial compression in cooperation with the corresponding lifting device 35.

Each operating group 27 is dimensioned in such a way that in use, the support body 28 performs at least one complete revolution around the rotation axis 29 while the processing discs 30 are arranged in the working position. Preferably, in use, the support body 28 performs at least two to three complete revolutions around the rotation axis 29 while the processing discs 30 are arranged in the working position.

In use, a cylindrical case 3 is inserted into a seat 26 in the interchange station S3. Subsequently, as the processing wheel 24 rotates around the rotation axis 25, the corresponding lifting device 35 with an upward axial movement removes the cylindrical case 3 from the seat 26 by coupling the cylindrical case 3 to the corresponding operating group 27 which is located above the seat 26; in this position, the cylindrical case 3 abuts at the top against the central abutment element 36.

Once the cylindrical case 3 has been coupled to the operating group 27 by the lifting device 35, the actuator device 34 moves the processing discs 30 from the loading/unloading position to the working position, and simultaneously the support body 28 begins to rotate around the rotation axis 29; as a result, the processing discs 30 tend to rotate on the side wall 4 of the cylindrical case 3 (which remains stationary by being pressed against the central abutment element 36); the radial movement of the processing discs 30 generated by the actuator device 34 causes the deformation of the side wall 4 of the cylindrical case 3 and thus forms the groove 10.

According to a preferred embodiment, the radial movement of the processing discs 30 occurs simultaneously with the rotation of the support body 28 around the rotation axis 29, so that the action of the processing discs 30 on the side wall 4 of the cylindrical case 3 is progressive.

Subsequently, when the cylindrical case 3 arrives in the vicinity of the exchange station S4, the rotation of the support body 28 is stopped, the actuator device 34 moves the processing discs 30 from the working position to the loading/unloading position, and the corresponding lifting device 35 with an axial downward movement uncouples the cylindrical case 3 from the corresponding operating group 27 which is located above the seat 26 and brings the cylindrical case 3 back in seat 26.

Finally, at the exchange station S4 the cylindrical case 3, now provided with the groove 10, leaves the corresponding seat 26 of the processing wheel 24.

As shown in FIG. 10, the manufacturing machine 19 comprises a horizontal transfer wheel 37 that is mounted to rotate around a vertical rotation axis 38 (parallel to the rotation axis 25), receives the cylindrical cases 3 in the exchange station S4 from the processing wheel 24, and leaves the cylindrical cases 3 at an exchange station S5.

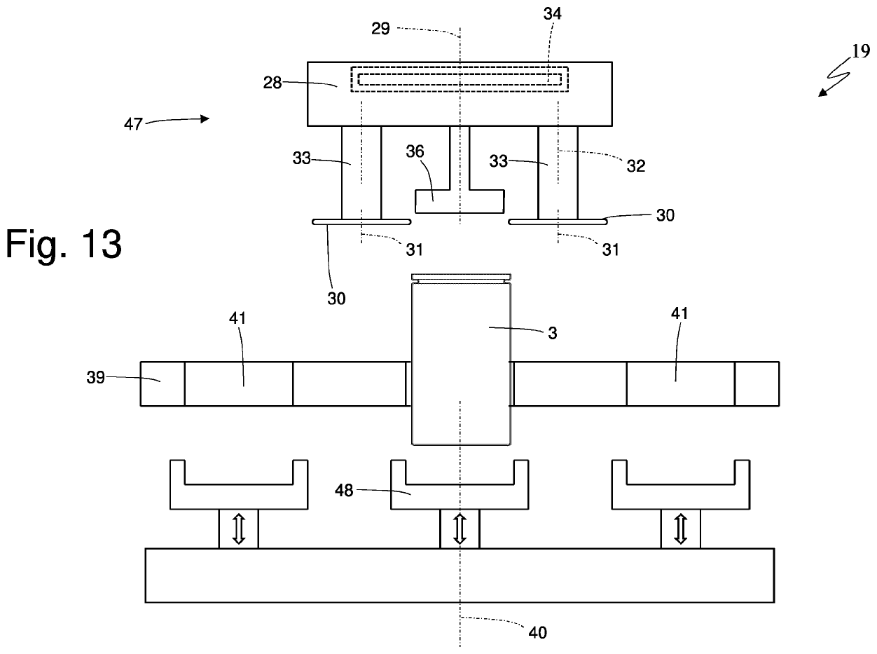

As shown in FIG. 10, the manufacturing machine 19 comprises a second horizontal processing wheel 39 that is mounted to rotate around a vertical rotation axis 40 (parallel to the rotation axis 38), receives the cylindrical cases 3 in the exchange station S5 from the transfer wheel 37 and leaves the cylindrical cases 3 at an exchange station S6. As shown in FIG. 13, the processing wheel 39 supports a plurality (e.g. twelve) of seats 41 which are evenly distributed along the periphery of the processing wheel 39 and are moved forward by the rotation of the processing wheel 39 around the rotation axis 40 along a circular processing path extending between the interchange stations S5 and S6 (i.e. the processing path starts at the interchange station S5 and ends at the interchange station S6). Each seat 41 is designed to laterally grab a corresponding cylindrical case 3 (i.e. the seat 41 engages part of the side wall 4 of the cylindrical case 3) by, for instance, retaining the cylindrical case 3 by suction; the cylindrical case 3 can thereby translate axially (i.e. parallel to the rotation axis 40) with respect to the corresponding seat 41 (according to ways described hereinafter).

As shown in FIG. 10, the manufacturing machine 19 comprises a feeding unit 42 which is configured to feed, at a feeding station S7 located between the exchange station S5 and the exchange station S6, on the upper end 7 of the cylindrical case 3 (i.e. above the cylindrical case 3) carried by each seat 41 an assembly consisting of a lid 8 and a gasket 9 superimposed on each other.

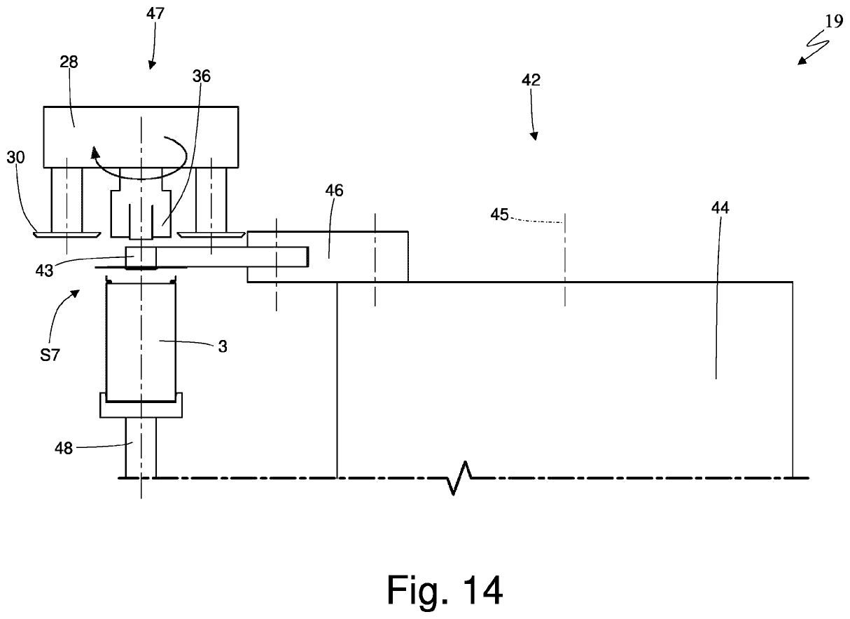

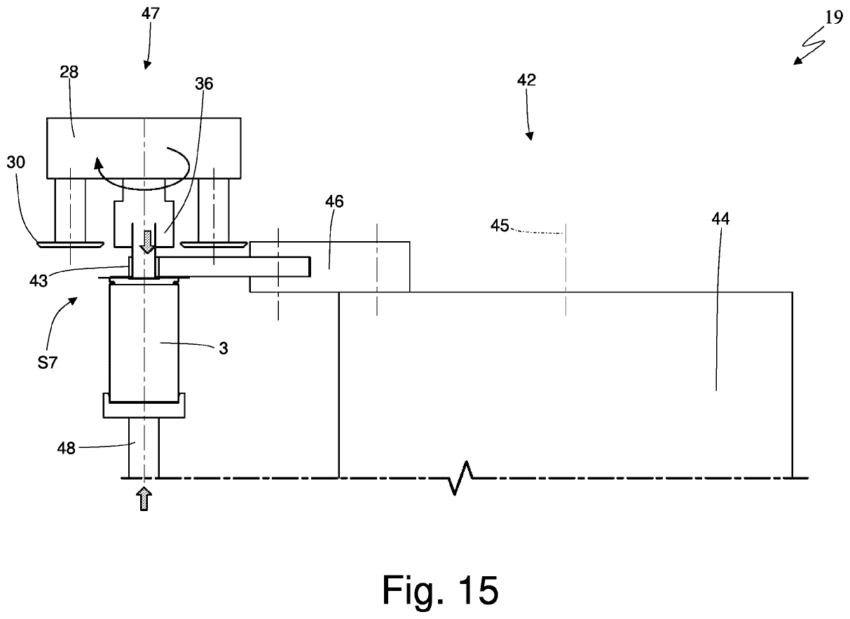

As shown in FIGS. 10, 14 and 15, the feeding unit 42 comprises a plurality (e.g. six) of suction gripping heads 43, each of which is designed to retain an assembly consisting of a lid 8 and a gasket 9 superimposed on each other. In addition, the feeding unit 42 comprises a feeding wheel 44 which is arranged alongside the processing wheel 39, is mounted to rotate around a vertical rotation axis 45 (parallel to the rotation axis 40), and supports the gripping heads 43 by interposing corresponding hinged arms 46. Preferably, each hinged arm 46 has a joint in the middle and therefore has two degrees of freedom. The rotation of the feeding wheel 44 around the rotation axis 45 leads each gripping head 43 through a pick-up station S8 wherein the gripping head 43 picks up a lid 8, then through a pick-up station S9 wherein the gripping head 43 picks up a gasket 9 which is superimposed on the previously picked up lid 8, and finally through the feeding station S7 wherein the assembly consisting of a lid 8 and a gasket 9 superimposed on each other is released on top of a cylindrical case 3 (as shown in FIGS. 14 and 15).

As shown in FIG. 13, each seat 41 of the processing wheel 39 is coupled with a corresponding operating group 47 which is carried by the processing wheel 39 to move (rotate) in an integral manner with the processing wheel 39. Each operating group 47 is configured to perform an initial (partial) bending of the edge 11 of the cylindrical case 3 brought from the corresponding seat 41 downstream of the feeding station S7 (i.e. after feeding the lid 8 and gasket 9). In other words, as many operating groups 47 as the seats 41 are provided and thus each operating group 47 always works with only one corresponding seat 41. Each operating group 47 is arranged along the processing path defined by the processing wheel 39 to perform a partial bending (shown in FIG. 7) of the edge 11 into a cylindrical case 3 that moves forward along the processing path supported by the corresponding seat 41. For sake of simplicity, only three seats 41 and only one operating group 47 are shown in FIG. 13, but actually twelve seats 41 and twelve corresponding operating groups 47 are provided.

As shown in FIG. 13, each operating group 47 is structurally entirely identical to the operating groups 27 described above, from which it differs essentially in the shape of the corresponding processing discs 30 which are configured to carry out different operations: in each operating group 27, the edge of each processing disc 30 constitutes a deforming tool 12 shown in FIG. 4 while in each operating group 47, the edge of each processing disc 30 constitutes a bending tool 14 shown in FIG. 7. Furthermore, in each operating group 27 a lower portion of the abutment element 36 defines (supports) the pressor element 13 shown in FIG. 4 while in each operating group 47 a lower portion of the abutment element 36 defines (supports) the pressor element 16 shown in FIG. 7. Similarly to the processing wheel 24, the processing wheel 39 also provides for each seat 41 a corresponding lifting device 48 which is carried by the processing wheel 39 to move (rotate) in an integral manner with the processing wheel 39 itself, is axially movable (i.e., along the rotation axis 40) and is configured to extract the cylindrical case 3 from the corresponding seat 41 by coupling the cylindrical case 3 to the corresponding operating group 47 (which is located above the seat 41) and re-insert the cylindrical case 3 into the corresponding seat 41 by uncoupling the cylindrical case 3 from the operating group 47. According to a possible embodiment shown in FIGS. 14 and 15, the abutment element 36 of each operating group 47 has a vertically movable pusher which performs a working stroke (from top to bottom) to transfer the assembly consisting of a lid 8 and a gasket 9 from the corresponding gripping head 43 to the upper end 7 of the underlying cylindrical case 3 (for this purpose, each gripping head 43 has a through-hole into which the pusher is inserted).

In use, a cylindrical case 3 is inserted into a seat 41 in the interchange station S5. Then, as the processing wheel 39 rotates around the rotation axis 40, the seat 41 passes through the feeding station S7 where the assembly consisting of a lid 8 and a gasket 9 is placed on top of the cylindrical case 3. Subsequently, as the processing wheel 39 rotates around the rotation axis 40, the corresponding lifting device 48 with an upward axial movement removes the cylindrical case 3 from the seat 41 coupling the cylindrical case 3 to the corresponding operating group 47 which is located above the seat 41; in this position, the cylindrical case 3 abuts against the central abutment element 36.

Once the cylindrical case 3 has been coupled to the operating group 47 by the lifting device 48, the actuator device 34 moves the processing discs 30 from the loading/unloading position to the working position and simultaneously the support body 28 begins to rotate around the rotation axis 29; as a consequence, the processing discs 30 tend to rotate on the side wall 4 of the cylindrical case 3 (which remains stationary being pressed against the central abutment element 36); the radial movement of the processing discs 30 generated by the actuator device 34 causes the partial bending of the edge 11 of the cylindrical case 3 (as shown in FIG. 7).

According to a preferred embodiment, the radial movement of the processing discs 30 occurs simultaneously with the rotation of the support body 28 around the rotation axis 29, so that the action of the processing discs 30 on the side wall 4 of the cylindrical case 3 is progressive.

Subsequently, when the cylindrical case 3 arrives in the vicinity of the exchange station S6, the rotation of the support body 28 is stopped, the actuator device 34 moves the processing discs 30 from the working position to the loading/unloading position, and the corresponding lifting device 48 with an axial downward movement uncouples the cylindrical case 3 from the corresponding operating group 47 which is located above the seat 41 and returns the cylindrical case 3 to the seat 41.

Finally, at the station S6 the cylindrical case 3, now provided with the lid 8 and gasket 9 leaves the corresponding seat 41 of the processing wheel 39.

As shown in FIG. 10, the manufacturing machine 19 comprises a third horizontal processing wheel 49 that is mounted to rotate around a vertical rotation axis 50 (parallel to the rotation axis 40), receives the cylindrical cases 3 in the exchange station S6 from the processing wheel 39 and leaves the cylindrical cases 3 at an exchange station S10. Namely, the processing wheel 39 is configured to directly transfer each cylindrical case 3 to the processing wheel 49 at the interchange station S6.

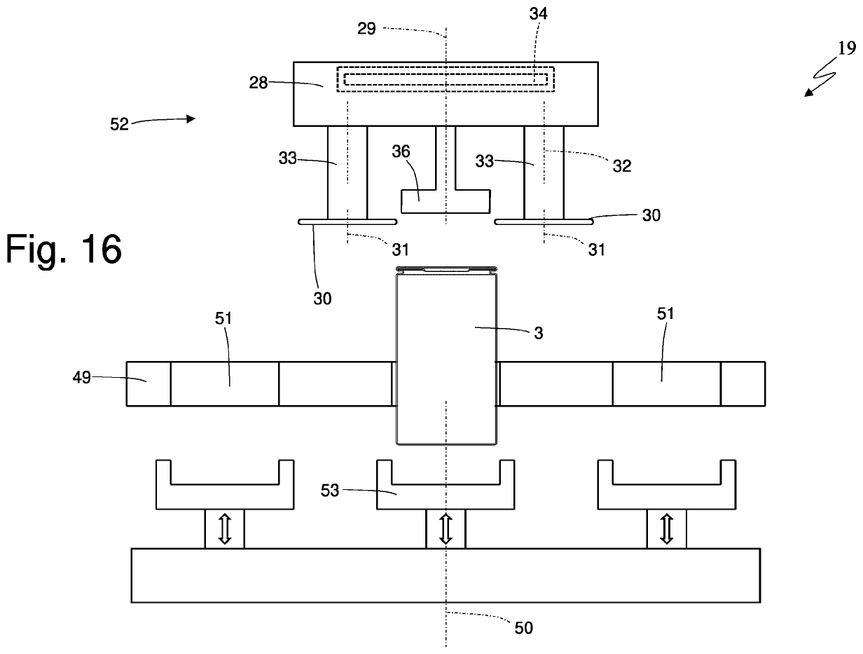

As shown in FIG. 16, the processing wheel 49 supports a plurality (e.g. twelve) of seats 51 which are evenly distributed along the periphery of the processing wheel 49 and are moved forward by the rotation of the processing wheel 49 around the rotation axis 50 along a circular processing path extending between the interchange stations S6 and S10 (i.e. the processing path starts at the interchange station S6 and ends at the interchange station S10). Each seat 51 is designed to laterally grab a corresponding cylindrical case 3 (i.e. the seat 51 engages part of the side wall 4 of the cylindrical case 3) by, for instance, retaining the cylindrical case 3 by suction; the cylindrical case 3 can thereby translate axially (i.e. parallel to the rotation axis 50) with respect to the corresponding seat 51 (according to ways described hereinafter).

As shown in FIG. 16, each seat 51 of the processing wheel 49 is coupled with a corresponding operating group 52 which is carried by the processing wheel 49 to move (rotate) in an integral manner with the processing wheel 49. Each operating group 52 is configured to perform a second (final) bending of the edge 11 of the cylindrical case 3 brought from the corresponding seat 51 to complete the folding of the edge 11 (as shown in FIG. 8). In other words, as many operating groups 52 as the seats 51 are provided and thus each operating group 52 always works with only one corresponding seat 51. Each operating group 52 is placed along the processing path defined by the processing wheel 49 to complete the bending of the edge 11 in a cylindrical case 3 moving forward along the processing path supported by the corresponding seat 51. For sake of simplicity, only three seats 51 and only one operating group 52 are shown in FIG. 16, but actually twelve seats 51 and twelve corresponding operating groups 52 are provided.

As shown in FIG. 16, each operating group 52 is structurally completely identical to the operating groups 27 and 47 described above, from which it differs essentially in the shape of the corresponding processing discs 30 which are configured to carry out different operations. In each operating group 27 the edge of each processing disc 30 constitutes a deforming tool 12 shown in FIG. 4; in each operating group 47 the edge of each processing disc 30 constitutes a bending tool 14 shown in FIG. 7, and in each operating group 52 the edge of each processing disc 30 constitutes a bending tool 15 shown in FIG. 8. Furthermore, in each operating group 27 a lower portion of the abutment element 36 defines (supports) the pressor element 13 shown in FIG. 4, in each operating group 47 a lower portion of the abutment element 36 defines (supports) the pressor element 16 shown in FIG. 7, and in each operating group 52 a lower portion of the abutment element 36 defines (supports) the pressor element 17 shown in FIG. 8. Similarly to the processing wheels 24 and 39, also the processing wheel 49 provides for each seat 51 a corresponding lifting device 53 which is carried by the processing wheel 49 to move (rotate) in an integral manner with the processing wheel 49 itself, is axially movable (i.e., along the rotation axis 50) and is configured to extract the cylindrical case 3 from the corresponding seat 51 by coupling the cylindrical case 3 to the corresponding operating group 52 (which is located above the seat 51) and re-insert the cylindrical case 3 into the corresponding seat 51 by uncoupling the cylindrical case 3 from the operating group 52.

In use, a cylindrical case 3 is inserted into a seat 51 in the interchange station S6. Subsequently, as the processing wheel 49 rotates around the rotation axis 50, the corresponding lifting device 53 with an upward axial movement removes the cylindrical case 3 from the seat 51 by coupling the cylindrical case 3 to the corresponding operating group 52 which is located above the seat 51; in this position, the cylindrical case 3 abuts against the central abutment element 36.

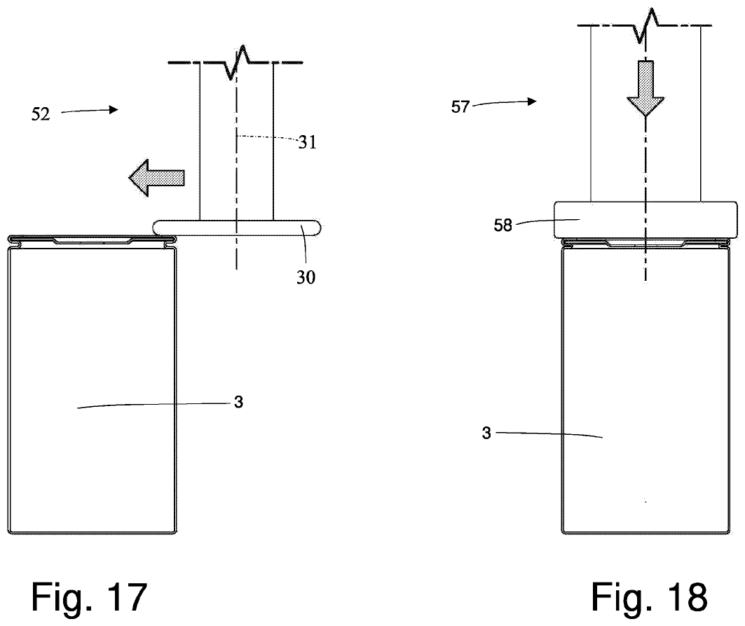

Once the cylindrical case 3 has been coupled to the operating group 52 by the lifting device 53, the actuator device 34 moves the processing discs 30 from the loading/unloading position to the working position and simultaneously the support body 28 begins to rotate around the rotation axis 29; as a result, the processing discs 30 tend to rotate on the side wall 4 of the cylindrical case 3 (which remains stationary being pressed against the central abutment element 36); the radial movement of the processing discs 30 generated by the actuator device 34 causes the edge 11 of the cylindrical case 3 to bend (as shown in FIG. 8 and also in FIG. 17).

According to a preferred embodiment, the radial movement of the processing discs 30 occurs simultaneously with the rotation of the support body 28 around the rotation axis 29, so that the action of the processing discs 30 on the side wall 4 of the cylindrical case 3 is progressive.

Subsequently, when the cylindrical case 3 arrives in the vicinity of the exchange station S10, the rotation of the support body 28 is stopped, the actuator device 34 moves the processing discs 30 from the working position to the loading/unloading position, and the corresponding lifting device 48 with an axial downward movement uncouples the cylindrical case 3 from the corresponding operating group 52 which is located above the seat 51 and returns the cylindrical case 3 to the seat 51.

According to a preferred embodiment, before arriving at the exchange station S10 the actuator device 34 moves the processing discs 30 from the working position to the loading/unloading position and the corresponding lifting device 48 slightly pushes, with an axial movement, the cylindrical case 3 upwards to perform the axial compression of the cylindrical case 3 as shown in FIG. 9; in this embodiment, the central abutment element 36 of each operating group 52 initially has the pressor element 17 shown in FIG. 8 to perform the bending of the edge 11 of the cylindrical case 3 and subsequently has the pressor element 18 shown in FIG. 9 to perform the axial compression of the cylindrical case 3. Namely, the central abutment element 36 of each operating group 52 comprises both pressor elements 17 and 18 which are axially movable and protrude from the lower wall of the central abutment element 36 when required.

Finally, at the interchange station S10, the cylindrical case 3 leaves the corresponding seat 51 of the processing wheel 49.

As shown in FIG. 10, the manufacturing machine 19 comprises a horizontal transfer wheel 54 that is mounted to rotate around a vertical rotation axis 55 (parallel to the rotation axis 50), receives the cylindrical cases 3 at the exchange station S10, and leaves the cylindrical cases 3 at an exchange station S11.

As shown in FIG. 10, the manufacturing machine 19 comprises a horizontal conveyor (not shown) that moves forward a series of cylindrical cases 3 containing the electrochemical cells and that are closed at the top along an exit path that begins at the exchange station S11.

As shown in FIG. 10, a control station S12 is arranged near the transfer wheel 54, in which an optical control device 56 verifies whether the upper end 7 of each cylindrical case 3 corresponds to the desired specifications; furthermore, a rejection station S13 is arranged near the transfer wheel 54 (obviously downstream of the control station S12) in which a cylindrical case 3 not fulfilling the desired specifications (i.e. defective) is discarded by being extracted from the transfer wheel 54 and is then directed to a rejection collection path.

According to a different embodiment shown in FIG. 18, the manufacturing machine 19 comprises a plurality of compression units 57 (only one of which is shown in FIG. 18) which are arranged (at least functionally) downstream of the operating groups 52. Each compression unit 57 is configured to axially compress a corresponding cylindrical case 3 in such a way as to plastically deform the groove 10 by compacting the entire upper end 7 of the cylindrical case 3 (as it is clear by comparing FIG. 9 showing a cylindrical case 3 prior to the axial compression and FIG. 2 showing a cylindrical case 3 after the axial compression). Specifically, each compression unit 57 comprises a hammer 58 that is axially movable to apply an axial compression to a corresponding cylindrical case 3. According to a possible embodiment, a further (fourth) processing wheel is provided which is interposed between the processing wheel 49 and the transfer wheel 54, rotates around a vertical rotation axis, is provided with a series of seats each designed to receive a cylindrical case 3, and is provided with a set of compression units 57 cooperating with the seats.

According to an alternative embodiment, the compression units 57 are integrated together with the operating groups 52 into the processing wheel 49, for example by replacing the abutment elements 36 of the operating groups 52 with the movable hammers 58 of the compression units 57: firstly (in the initial part of the processing path) the operating groups 52 act to complete the bending of the edge 11 of the cylindrical cases 3 and then (in the final part of the processing path) the compression units 57 act to axially compress the cylindrical cases 3.

According to a further embodiment, the compression units 57 replace the operating groups 52 in the processing wheel 49 and thus become bending and compression units 57: for each bending and compression unit 57, a first (initial) part of the stroke of the hammer 58 completes the bending of the edge 11 of a corresponding cylindrical case 3, while a second (final) part of the stroke of the hammer 58 axially compresses the corresponding cylindrical case 3.

According to a preferred embodiment, the manufacturing machine 19 is a continuous-type machine, i.e. it operates using a continuous-type law of motion whereby the conveyors do not cyclically alternate between stop and motion steps and instead have a constant forward speed (which obviously increases or decreases as the hourly output at which the manufacturing machine 19 operates increases or decreases). Consequently, all the processing wheels 24, 39 and 49 rotate with a continuous law of motion around the corresponding rotation axes 25, 40 and 50.

According to a different embodiment not shown, there are no operating groups 47 coupled to the processing wheel 39 and the bending of the edge 11 of each cylindrical case 3 is carried out in a single step (instead of two successive steps) by operating groups 52 coupled to the processing wheel 49.

It is important to note that the operating groups 27, the operating groups 47 and the operating groups 52 are structurally identical and differ from each other only in the type of operating tools installed (i.e. the processing discs 30 are shaped differently); consequently, the processing wheels 24, 39 and 49 are also structurally identical. In this way, a single complex object is designed and built which is replicated several times (in a sort of “copy & paste”) to make up all the three processing wheels 24, 39 and 49 and all the operating groups 27, 47 and 52.

The herein described embodiments may combine one another without departing from the scope of protection of the present invention.

The above-described manufacturing machine 19 has several advantages.

Firstly, the above-described manufacturing machine 19 allows to operate at a high production speed (i.e. a high number of cylindrical cases 3 produced in a unit of time) without damaging the cylindrical cases 3 themselves. This result is achieved thanks to the special structure of the manufacturing machine 19 which allows its conveyors to operate with continuous laws of motion.

The above-described manufacturing machine 19 is particularly compact and provides an excellent accessibility to all its components for adjustment, format change, maintenance and repair operations.

The above-described manufacturing machine 19 allows the format of the cylindrical cases 3 to be changed relatively easily and quickly.

Finally, the above-described manufacturing machine 19 is also of simple construction and cost-effective by replicating exactly the same type of structure several times.

### LIST OF REFERENCE NUMBERS OF THE FIGURES

1 cylindrical battery
2 electrochemical cell
3 cylindrical case
4 side wall
5 lower end
6 lower wall
7 upper end
8 lid
9 gasket
10 groove
11 edge
12 deforming tool
13 pressor element
14 bending tool
15 bending tool
16 pressor element
17 pressor element
18 pressor element
19 manufacturing machine
20 transfer wheel
21 rotation axis
22 transfer wheel
23 rotation axis
24 processing wheel
25 rotation axis
26 seats
27 operating group
28 support body
29 rotation axis
30 processing discs
31 rotation axis
32 rotation axis
33 columns
34 actuator device
35 lifting device
36 abutment element
37 transfer wheel
38 rotation axis
39 processing wheel
40 rotation axis
41 seats
42 feeding units
43 gripping head
44 feeding wheel
45 rotation axis
46 hinged arm
47 operating group
48 lifting device
49 processing wheel
50 rotation axis
51 seats
52 operating group
53 lifting device
54 transfer wheel
55 rotation axis
56 control device
57 compression unit
58 hammer
S1 interchange station
S2 interchange station
S3 interchange station
S4 interchange station
S5 interchange station
S6 interchange station
S7 feeding station
S8 pick-up station
S9 pick-up station
S10 interchange station
S11 interchange station
S12 control station
S13 rejection station

1. A manufacturing machine to manufacture a cylindrical battery comprising a cylindrical case which houses an electrochemical cell, the manufacturing machine comprising:
a processing conveyor configured to move forward along a processing path a seat designed to support the cylindrical case; and
an operating group which is arranged along the processing path and is configured to perform processing on the cylindrical case;
wherein the operating group comprises:
a support body, which is axially aligned with the seat and is mounted so as to rotate around a first rotation axis; and
a plurality of processing discs, which are designed to perform processing on a side wall of the cylindrical case, are mounted on the support body so as to form a circle at a center of the cylindrical case, and in use, is placed and is radially movable so as to radially get close to and move away from the cylindrical case which is in use between the plurality of processing discs.

2. The manufacturing machine according to claim 1, wherein each processing disc of the plurality of processing discs is mounted on the support body in a rotary manner so as to rotate around a second rotation axis, which is parallel to the first rotation axis.

3. The manufacturing machine according to claim 1, wherein each processing disc of the plurality of processing discs is mounted in an idle manner so as to freely rotate around a second rotation axis.

4. The manufacturing machine according to claim 2, wherein each processing disc of the plurality of processing discs is mounted on the support body in a rotary manner so as to rotate around a third rotation axis parallel to the second rotation axis and eccentric with respect to each processing disc in such a way that the rotation around the third rotation axis causes a radial displacement of the processing disc.

5. The manufacturing machine according to claim 4, wherein each processing disc is mounted on the support body in a rotary manner so as to rotate around a third rotation axis and the operating group comprises an actuator device which is configured to rotate all processing discs of the plurality of processing discs in a synchronized manner around the third rotation axes between a loading/unloading position in which the plurality of processing discs are at a non-zero distance from the cylindrical case which is, in use, between the plurality of processing discs and a working position in which the plurality of processing discs touch the cylindrical case which is in use between the plurality of processing discs.

6. The manufacturing machine according to claim 2, wherein the operating group comprises a plurality of columns, each of which at one end supports a corresponding processing disc of the plurality of processing discs which is mounted to rotate about the second rotation axis with respect to the column and at an opposite end is hinged to the support body to rotate around a third rotation axis.

7. The manufacturing machine according to claim 1, comprising a lifting device which is axially movable and is configured to extract the cylindrical case from the seat by coupling the cylindrical case to the operating group and to insert the cylindrical case again into the seat by uncoupling the cylindrical case from the operating group.

8. The manufacturing machine according claim 1, wherein in a middle of the support body a central abutment element is arranged, which does not rotate with the support body and against which the cylindrical case that is coupled to the operating group is pushed.

9. The manufacturing machine according to claim 1, wherein the plurality of processing discs are evenly distributed around the first rotation axis.

10. The manufacturing machine according to claim 1, wherein the operating group is configured to move together with the processing conveyor in an integral manner.

11. (canceled)
